(19) United States
(12) Patent Application Publication
(10) Pub. No.: US 2008/0269426 A1
(43) Pub. Date: Oct. 30, 2008

(54) Method for Producing a Polyalkenyl Amine

(75) Inventors: Stefan Bitterlich, Dirmstein (DE); Thomas Wettling, Limburgerhof (DE); Peter Spang, St Ingbert (DE); Helmut Schmidtke, Bensheim (DE); Klaus Diehl, Hassloch (DE); Andreas Bode, Mannheim (DE); Matthias Frauenkron, Freinsheim (DE); Marc Walter, Frankenthal (DE); Erich K. Fehr, Vellmar (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF AKTIENGESELLSCHAFT, LUDWIGSHAFEN (DE)

(21) Appl. No.: 11/917,816

(22) PCT Filed: Jun. 23, 2006
(86) PCT No.: PCT/EP06/06074

§ 371 Date: Dec. 17, 2007

(30) Foreign Application Priority Data
Jun. 24, 2005 (DE) 10 2005 029 423.5

(51) Int. Cl. C08F 8/30; C08F 8/32

(52) U.S. Cl. 525/378; 525/379

(57) ABSTRACT

The present invention relates to a process for preparing a polyalkenylamine, in which the solvent used for the reaction is exchanged for a different solvent.

The present invention relates to a process for preparing a polyalkenylamine, in which the solvent used for the preparation is exchanged for a different solvent.

Polyalkenylamines, especially polybutenylamines and polyisobutenylamines (polyisobuteneamines PIBA), have found wide use as fuel and lubricant additives. They play, for example, an important role in keeping valves and carburetors or injection systems of gasoline engines clean and are part of commercial additive packages, as are sold, for example, under the name Kerocom® PIBA from BASF Aktiengesellschaft. They are prepared starting from polyalkenes which still have ethylenically unsaturated double bonds by hydroformylation and subsequent hydrogenating amination, as described, for example, in EP-A-244 616.

The hydroformylation and/or the reductive amination are effected typically in the presence of a solvent in order to lower the viscosity of the high molecular weight feedstocks and thus, for example, to ease the removal of the heat of the reaction and the workup. In many cases, the commercial form of the polyalkenylamines is likewise a solution, in which case the process solvent generally remains in the end product after the reaction. However, it has been found that, for various reasons, it can be advantageous to replace the solvent used for the preparation with another solvent to formulate the commercial form. For instance, the requirements on the process solvent which result from the preparation process, for example with regard to a low content of aromatics and sulfur compounds, necessitate the use of costly solvents or complicated pretreatment steps. However, these solvents do not lead in many cases to an improvement in the properties of the commercial form, for example with regard to its property when it is used as a fuel and lubricant additive. Furthermore, the desire may be to provide a commercial product in a solvent for which the performance properties of the product are influenced in a controlled manner by the solvent. For instance, the authorities in many cases place certain demands on commercial products, for example with regard to a sufficiently high flashpoint, which cannot be satisfied by the process solvent. Furthermore, it may be advantageous for the provision of additive packages with complex property profile to improve certain performance properties by means of the solvent used for the formulation. For this purpose, it is necessary, for example, that the solvent used to formulate the commercial form has certain chemical properties, for example functional groups such as amine, alcohol or aldehyde functions.

It is an object of the present invention to provide a process for preparing a polyalkenylamine which does not have the aforementioned disadvantages. Accordingly, a process has been found for preparing a polyalkenylamine, in which
a) a component which comprises at least one monounsaturated polyalkene is reacted with carbon monoxide and hydrogen to obtain a hydroformylated polyalkene, and
b) the resulting hydroformylated polyalkene is reacted with hydrogen and ammonia or an amine which has at least one primary or secondary amino group to give the polyalkenylamine,
   which comprises, before carrying out at least one of steps a) and b), dissolving the polyalkene or the hydroformylated polyalkene in a first solvent and replacing the first solvent with a second solvent after this or the next step.

The process according to the invention comprises various embodiments. For instance, the first solvent can be added as early as before step a) or not until before step b). This depends, for example, upon the molecular weight and hence the viscosity of the polyalkenes used in step a) and/or of the resulting hydroformylated polyalkenes. When the first solvent is used in step a), the replacement by the second solvent may be effected after step a) or after step b). Preference is given to carrying out both steps a) and b) in the presence of the first solvent and replacing the first solvent with the second solvent after step b). A solvent exchange between step a) and step b) is less preferred.

The removed first solvent is advantageously recycled into step a) and/or b) in which it is used as the solvent. In this way, the process according to the invention, apart from supplementations which become necessary as a result of unavoidable losses, requires an amount of the first solvent to be provided only once.

“Replacement” or “exchange” of the first solvent with the second solvent is intended to mean that the solution of the polyalkenylamine in the second solvent which results from the process according to the invention comprises at most 10% by weight, more preferably at most 5% by weight, in particular at most 1% by weight, of the first solvent. When the first solvent used is a solvent mixture, the solution of the polyalkenylamine in the second solvent comprises preferably at most 10% by weight, more preferably at most 5% by weight, in particular at most 1% by weight, of one or more components of the first solvent mixture. The isolated and recycled first solvent comprises at most 10% by weight, more preferably at most 5% by weight, in particular at most 1% by weight, of the second solvent or (in the case of solvent mixtures) of at least one component of the second solvent.

When the first solvent is replaced by the second solvent, it is preferred that a solution never occurs which comprises the polyalkenylamine in a concentration of more than 90% by weight, more preferably more than 70% by weight (i.e. the solution comprising the polyalkenylamine comprises the polyalkenylamine in a concentration of at most 90% by weight, more preferably of at most 70% by weight).

The solution of the polyalkenylamine in the second solvent obtained in the process according to the invention preferably has a content of polyalkenylamine of from 10 to 90% by weight, preferably from 20 to 70% by weight.

The first solvent is exchanged for the second solvent preferably by distillation. To this end, the first solvent is distilled out of the solution of the polyalkenylamine and the second solvent is added continuously or periodically thereto. In that case, the second solvent used is preferably a medium having a higher boiling point than the first solvent, and the second solvent is preferably added at least partly before and/or during the distillation in order to prevent unnecessary thermal stress on the dissolved product. Suitable embodiments of the solvent exchange by distillation are described in detail below. The distillation may be carried out continuously or batchwise (discontinuously).

The first solvent and the second solvent are preferably selected in such a way that the boiling point or the final boiling point of the first solvent is at least 5 K, preferably at least 10 K, in particular at least 20 K, lower than the boiling point or the initial boiling point of the second solvent. When the solvents are exchanged by distillation in such a way that the second solvent is added at least partly during distillation, it is possible to successfully prevent the polyalkenylamine from having to temporarily be present substantially free of solvent. Thus, it is possible to successfully prevent undesired high viscosity and also increased thermal stress on the product or the need for a high vacuum.

Suitable first solvents are preferably saturated aliphatic hydrocarbons (also known as alkanes or paraffins), saturated cyclic hydrocarbons (cycloalkanes) which may be used either as pure components or in the form of mixtures. Preference is given to hydrocarbons having a carbon atom number in the range from 5 to 12, in particular from 6 to 10. These include, for example, n-pentane, n-hexane, n-heptane, n-octane, n-nonane, n-decane, the branched isomers of the aforementioned alkanes, cycloalkanes such as cyclohexane and its alkylated derivatives and mixtures thereof. Commercially available solvent mixtures suitable as first solvents are, for example, mineral oil fractions which comprise only small fractions of aromatics, if any, in particular hydrogenated mineral oil fractions which are obtainable as so-called special-boiling-point spirits. An example of a particularly suitable special-boiling-point spirit is obtainable under the name SBP 100/140. This is a hydrogenated petroleum fraction which consists substantially of n-, iso- and cycloaliphatics having a carbon atom number in the range from 7 to 8. Its boiling range is in the range from 100 to 140° C.

The first solvent has a content of aromatic compounds of preferably at most 20% by weight, more preferably at most 10% by weight, in particular at most 5% by weight and especially at most 2% by weight. The concentration of elemental or chemically bonded sulfur in the first solvent is preferably at most 20 ppm by weight, more preferably at most 10 ppm by weight, in particular at most 5 ppm by weight and especially at most 2 ppm by weight.

Suitable second solvents are in principle aliphatic or aromatic hydrocarbons which may be used either in the form of the pure components or of mixtures. Preference is given to aromatic hydrocarbons and hydrocarbon mixtures which comprise at least one aromatic hydrocarbon. The second solvent is preferably selected from hydrocarbons having a carbon atom number in the range from 6 to 30, more preferably from 8 to 20. The second solvent is preferably aromatic hydrocarbons such as benzene, toluene or xylenes, or technical-grade hydrocarbon mixtures having a fraction of aromatic compounds of, for example, at least 20% by weight. Generally less stringent demands are placed on the second solvent with regard to uniform composition and purity than on the first solvent, so that more poorly-defined technical-grade mixtures which are available in large volume at relatively low cost are also suitable here. These include xylenes and kerosenes. Kerosenes are fractions obtained in the distillation of mineral oil between petroleum spirits and diesel fuels. They are substantially hydrocarbons having from 10 to 16 carbon atoms. The kerosenes boil preferably between 150 and 325° C. The mineral oil fractions used are preferably those known as “white spirits”. They are mixtures of paraffins, cycloparaffins and aromatic hydrocarbons having boiling ranges of from 150 to 220° C. “White spirits” are commercially available, for example, from Shell under the name “Mineral Spirits 135” and SHELLSOL H, these being so-called LAWS (Low Aromatic White Spirits).

The hydroformylation of substantially monoethylenically unsaturated polyalkenes of step a) and the subsequent reducing amination of step b) are prior art and are described, for example, in EP-A-0 244 616, which is fully incorporated here by reference.

The substantially monounsaturated polyalkenes used in step a) preferably have a number-average molecular weight of from 200 to 80 000, preferably from 400 to 50 000. They are in particular oligo- or polymerization products of propene, butene or isobutene. Component a) is preferably a polyisobutene-containing component based on low molecular weight or medium molecular weight reactive polyisobutenes. Suitable low molecular weight polyisobutenes have a number-average molecular weight in the range from about 200 to less than 5000, preferably from 300 to 4000, in particular from 500 to 2000. Suitable medium molecular weight polyisobutenes have a number-average molecular weight Mn in the range from about 5000 to 80 000, preferably from 10 000 to 50 000 and especially from 20 000 to 40 000. Preference is given to “reactive” polyisobutenes which differ from the “low-reactivity” polyisobutenes by the content of double bonds in the α- or β-position. Component a) preferably comprises at least one polyisobutene having a fraction of α- and/or β-double bonds of at least 50 mol %, more preferably at least 60 mol % and especially at least 80 mol %.

The polyisobutenes used in accordance with the invention preferably have a narrow molecular weight distribution. Their polydispersity (M_{w}/Mₙ) is preferably in a range from 1.05 to 4, for example from 2 to 3. If desired, it may even be higher, for example greater than 5 or even greater than 12.

The polyisobutenes used in accordance with the invention are preferably substantially homopolymeric polyisobutenes.

In the context of this invention, a substantially homopolymeric polyisobutene is understood to mean a polyisobutene which consists to an extent of more than 90% by weight of isobutene units. Suitable comonomers are C₃-C₆-alkenes, preferably n-butene. Preparation and structure of the oligo-/polyisobutenes are known to those skilled in the art (for example Günther, Maenz, Stadermann in Ang. Makrom. Chem. 234, 71 (1996)).

Preference is given to using polyisobutenes which may, if desired, comprise up to 10% n-butene incorporated as a comonomer. Such polyisobutenes are prepared, for example, from butadiene-free C₄ cuts which generally comprise, as a result of the production, not only isobutene but also n-butene. Particular preference is given to isobutene homopolymers.

Particularly suitable low molecular weight reactive polyisobutenes are, for example, the Glissopal® brands from BASF Aktiengesellschaft, in particular Glissopal 1000 (M_{N}=1000) and Glissopal V 33 (M_{N}=550) and mixtures thereof with a number-average molecular weight M_{N}<1000. Other number-average molecular weights may be established in a manner known in principle by mixing polyisobutenes of different number-average molecular weights or by extractive enrichment of polyisobutenes of certain molecular weight ranges.

Particularly suitable medium molecular weight reactive polyisobutenes are, for example, the Oppanol® brands from BASF Aktiengesellschaft, for example B10-SFN, B12-SFN, B15-SFN (number-average molecular weight Mₙ=18 000, 25 000, 32 000 daltons). Particular preference is given to polyisobutenes which are terminated to an extent of at least 60 mol % with methylvinylidene groups (—C(—CH₃)═CH₂) and/or dimethylvinyl groups (—CH═C(CH₃)₂).

Suitable medium molecular weight reactive polyisobutenes and processes for their preparation are described in EP-A-0 807 641, which is fully incorporated by reference.

Suitable catalysts for the hydroformylation in step a) are known and comprise preferably a compound or a complex of an element of transition group VIII of the periodic table, such as Co, Rh, Ir, Ru, Pd or Pt. To influence activity and/or selectivity, preference is given to using hydroformylation catalysts modified with N- or P-containing ligands. Suitable salts of these metals are, for example, the hydrides, halides, nitrates, sulfates, oxides, sulfides or the salts with alkyl- or arylcarboxylic acids or alkyl- or arylsulfonic acids. Suitable complexes have ligands which are, for example, selected from halides, amines, carboxylates, acetylacetonate, aryl- or alkylsulfonates, hydride, CO, olefins, dienes, cycloolefins, nitriles, N-containing heterocycles, aromatics and heteroaromatics, ethers, PF₃, phospholes, phosphabenzenes, and also mono-, bi- and multidentate phosphine, phosphinite, phosphonite, phosphoramidite and phosphite ligands.

In a preferred embodiment, the hydroformylation catalysts are prepared in situ in the reactor used for the hydroformylation reaction.

Another preferred form is the use of a carbonyl generator in which presynthesized carbonyl is adsorbed, for example, on activated carbon and only the desorbed carbonyl is supplied to the hydroformylation, but not the salt solutions from which the carbonyl is generated.

Suitable rhodium compounds or complexes are, for example, rhodium(II) and rhodium(III) salts, such as rhodium(III) chloride, rhodium(III) nitrate, rhodium(III) sulfate, potassium rhodium sulfate, rhodium(II) or rhodium(II) carboxylate, rhodium(II) and rhodium(III) acetate, rhodium(III) oxide, salts of rhodium(III) acid, trisammonium hexachlororhodate(III) etc. Also suitable are rhodium complexes such as rhodium biscarbonyl acetylacetonate, acetylacetonatobisethylenerhodium(I), etc.

Likewise suitable are ruthenium salts or compounds. Suitable ruthenium salts are, for example, ruthenium(III) chloride, ruthenium(IV) oxide, ruthenium(VI) oxide or ruthenium(VIII) oxide, alkali metal salts of the ruthenium-oxygen acids such as K₂RuO₄ or KRuO₄, or complexes, for example RuHCl(CO)(PPh₃)₃. It is also possible to use the metal carbonyls of ruthenium, such as trisruthenium dodecacarbonyl or hexaruthenium octadecacarbonyl, or mixed forms in which CO has been replaced partly by ligands of the formula PR₃, such as Ru(CO)₃(PPh₃)₂.

Suitable cobalt compounds are, for example, cobalt(II) chloride, cobalt(II) sulfate, cobalt(II) carbonate, cobalt(II) nitrate, their amine or hydrate complexes, cobalt carboxylates such as cobalt formate, cobalt acetate, cobalt ethylhexanoate, cobalt naphthanoate, and also the cobalt caprolactamate complex. Here too, it is possible to use the carbonyl complexes of cobalt, such as dicobalt octacarbonyl, tetracobalt dodecacarbonyl and hexacobalt hexadecacarbonyl.

The compounds mentioned and further suitable compounds are known in principle and are described sufficiently in the literature.

Suitable activating agents which can be used for the hydroformylation are, for example, Bro/nsted acids, Lewis acids, for example BF₃, AlCl₃, ZnCl₂, and Lewis bases.

The composition of the synthesis gas composed of carbon monoxide and hydrogen used may vary within wide ranges. The molar ratio of carbon monoxide and hydrogen is generally from about 5:95 to 95:5, preferably from about 40:60 to 60:40. The temperature in the hydroformylation is generally in a range from about 20 to 200° C., preferably from about 50 to 190° C. The reaction is carried out generally at the partial pressure of the reaction gas at the selected reaction temperature. In general, the pressure is in a range from about 1 to 700 bar, preferably from 1 to 300 bar.

The predominant portion of the double bonds present in the polyisobutene used is preferably converted to aldehydes by the hydroformylation.

The hydroformylated polyalkenes obtained in step a) are further functionalized in step b) by subjecting them to a reaction with hydrogen and ammonia or a primary or secondary amine in the presence of an amination catalyst to obtain a polyalkene functionalized at least partly with amine groups.

Suitable amination catalysts are in principle all hydrogenation catalysts, preferably copper, cobalt or nickel, which can be used in the form of the Raney metals or on a support. Also suitable are platinum catalysts.

The amination with ammonia affords aminated polyisobutenes with primary amino functions. Primary and secondary amines suitable for the amination are, for example, compounds of the general formulae R—NH₂ and RR′NH, in which R and R′ are each independently alkyl radicals.

Preference is given to carrying out steps a) and b) in the first solvent and to subjecting the effluent from step b) to at least one additional workup step to remove at least one reactant and/or at least one by-product and/or at least a portion of the first solvent. Additional workup steps are possible in principle before, during or after a distillative solvent exchange. In a suitable version of the process according to the invention, the effluent from step b) is subjected to a single- or multistage separating operation to obtain at least one stream comprising the majority of the polyalkenylamine in the first solvent and a stream substantially comprising unconverted ammonia or amine. Depending on factors such as the type of discharge process, purity of the synthesis gas used, purity of the ammonia/amine used, etc., further streams are obtained if appropriate, such as offgases, for example from the synthesis gas, low boilers, inerts, streams which comprise hydroformylation and/or amination catalysts and, if appropriate after workup, are recycled fully or partly into reaction steps a) and/or b) or discharged from the process.

Appropriately, a stream comprising the ammonia used in step b) or the amine used in step b) is removed first from the effluent from reaction step b). For this purpose, reaction step b) is appropriately followed by at least one degassing step. In this step, the effluent from step b) is decompressed in the degassing step(s) in a suitable apparatus to a reduced pressure compared to the preceding reaction step b), or, in the case of several apparatuses, to a reduced pressure compared to the preceding apparatus, and a gas is drawn off which comprises, inter alia, unconverted hydrogen and ammonia or the amine used. This stream may in each case be recycled fully or partly upstream of step b) or discharged from the process.

This is preferably followed by a process step in which a substantial portion of the unconverted ammonia or amine is removed. This is preferably done in a distillation column by feeding the degassed stream from the preceding step at a suitable point in the column and drawing off a top product comprising substantially ammonia or the amine and a bottom product comprising substantially the reaction product and the inventive solvent. The apparatus configuration of the distillation column and the setting of the operating parameters lie within the ability of the skilled person. The top product may be introduced into step b) as a recycle stream. The bottom product is sent to the solvent exchange.

The exchange of the solvent by distillation can be effected continuously or discontinuously (batchwise), preferably continuously. The second solvent is added preferably, as already stated, at least partly before and/or during the distillation. The distillation itself may be effected in one distillation column or in a plurality of distillation columns coupled to one another. For distillation, preference is given to using a reaction effluent from step b), if appropriate after ammonia or amine removal, which comprises the first solvent in a concentration of from 20 to 60% by weight, more preferably from 30 to 50% by weight. The distillation column(s) is/are selected and operated in such a way that the distillate obtained comprises at most 10% by weight, more preferably at most 1% by weight, of one or more constituents of the second solvent. In addition, the bottom product obtained comprises at most 10% by weight, more preferably at most 1% by weight, of one or more constituents of the first solvent.

The distillation column or the distillation columns used may be realized in a design known per se (see, for example, Sattler, Thermische Trennverfahren [Thermal Separating Processes], 2^{nd} edition 1995, Weinheim, p. 135ff; Perry's Chemical Engineers Handbook, 7^{th} edition 1997, New York, Section 13). The distillation columns used may comprise separating internals such as separating trays, for example perforated trays, bubble-cap trays or valve trays, structured packings, for example sheet metal or fabric packings, or random beds of packings. In the case of use of tray columns with downcomers, the downcomer residence time is preferably at least 5 seconds, more preferably at least 7 seconds. The number of stages needed in the column(s) used and the reflux ratio depends substantially upon the purity requirements and the relative boiling point of the first and second solvent, and the skilled person can determine the specific design and operating data by known methods.

The liquids occurring in the distillation preferably at no point comprise more than 90% by weight, more preferably not more than 70% by weight, of polyalkenylamine.

Preference is given to operating the column(s) in such a way that the F factor (gas velocity×√gas density) does not exceed a value of 1 Pa^{0.5}, preferably 0.5 Pa^{0.5}, at any of the points coming into contact with a solution of the polyalkenylamine. The liquid hourly space velocity at the points coming into contact with solutions of the polyalkenylamine is preferably at most 20 m³/m²/h, preferably 10 m³/m²/h.

The bottom temperatures occurring in the distillation are preferably at most 220° C., more preferably at most 200° C. To maintain these maximum temperatures, the distillation can, if desired, be carried out under a suitable vacuum.

In order to prevent accumulation of undesired components in the process, it may be advantageous during distillative solvent exchange to remove and to discharge a fraction enriched in low boilers. In a suitable embodiment, a distillation process can be used for this purpose, which is operated in such a way that a top product which comprises the low boilers to be removed is obtained. In that case, this top product preferably comprises at most 50% by weight, more preferably at most 30% by weight, of the first solvent. Thus, an undesired loss of first solvent via a fraction not recycled into the process is prevented. The stream comprising the substantial portion of the first solvent is then drawn off via another point whose position depends upon the selection of the apparatus variant (see below), and, if appropriate after further workup, recycled into step a) and/or b).

The solvent exchange and the low boiler removal can be combined in various ways:

In a suitable embodiment, distillation is effected by using a so-called dividing wall column, i.e. feed point and a side draw are disposed on opposite sides of a dividing wall which extends over a section of the longitudinal dimension of the column. Such distillation columns which comprise a dividing wall are known per se to those skilled in the art. When side draw and feed are disposed in the region of the dividing wall, a system analogous to a Brugma or Petlyuk system is the result. Such distillations using dividing wall columns are described in DE-A-33 02 525 and EP-A-0 804 951, which are fully incorporated here by reference. In this case, the top product drawn off is the fraction enriched in low boilers, and the side draw the stream comprising the substantial portion of the first solvent. The second solvent is supplied below the feed point, preferably into the bottom of the column, and the solution of the polyalkenylamine in the second solvent is obtained as the bottom product.

In an alternative embodiment, distillation is effected by using coupled columns, which are likewise known per se and familiar to those skilled in the art. In that case, preference is given to removing low boilers by using a combination of two distillation columns. In this case, the low boilers to be discharged are withdrawn as the top product of the first column, and the stream comprising the substantial portion of the first solvent is obtained as the top product of the second column and the solution of the polyalkenylamine in the second solvent as the top product of the second column. In that case, the second solvent is preferably added into the bottom of the second column. The above-specified values for the polyalkenylamine combination, the F factor, the liquid hourly space velocity and the bottom temperature applies in this case to both columns.

Suitable evaporators and condensers are likewise apparatus types known per se. The evaporator used is preferably an evaporator with forced circulation, more preferably a falling-film evaporator. When two distillation columns are used for the distillation, this applies to both columns.

In a preferred embodiment, the reaction effluent from stage b) or a subsequent ammonia/amine removal before the distillation is fed to a heat exchanger and the heat obtained in this way is used in the subsequent solvent exchange by distillation, for example for heating the second solvent supplied in the distillation.

In a preferred embodiment of the process according to the invention, the stream comprising substantially the first solvent, before it is recycled into the process, is subjected to at least one additional workup step to remove nitrogen-containing components.

In general, the stream of the first solvent obtained in the distillative solvent exchange may still comprise up to 2% by weight of nitrogen-containing impurities, for example unconverted amines from the reductive amination. Since nitrogen-containing impurities can have an adverse effect especially on the hydroformylation catalyst used in step a), it is advantageous, before the first solvent is recycled into step a), to reduce the content of nitrogen-containing components as far as possible, preferably down into the ppm range.

Suitable workup methods comprise extraction, adsorption and combinations thereof. Preference is given to removing nitrogen-containing components by using an extraction, in particular a liquid/liquid extraction. The number of extraction stages is preferably in a range from 1 to 20 stages.

Suitable extractants are alcohols, preferably C₁-C₆-alcohols, such as methanol, ethanol, n-propanol, isopropanol, ethylene glycol, diethylene glycol, triethylene glycol, etc., or ionic liquids. Likewise suitable are water and mixtures of the aforementioned alcohols with water. When these extractants are used, it is substantially a physical extraction.

Preference is given to using extractants which comprise at least one inorganic or organic acid. The extractant is preferably aqueous, i.e. water or mixtures of water and at least one water-miscible solvent, for example at least one of the aforementioned alcohols. The pH of the extractant is preferably in a range from 0 to 6, more preferably from 2 to 4. The pH can be adjusted by adding an inorganic acid such as sulfuric acid or phosphoric acid, or, preferably, an organic acid such as formic acid, acetic acid, propionic acid, etc. The acid used is preferably selected from formic acid and sulfuric acid. In particular, formic acid is used. The amount of acid used is preferably from 0.1 to 50% by mass based on the total mass of the extractant. In the case of the above-described extractants, the extraction is performed as a combination of physical and chemical extraction. This extraction process, also known as reactive extraction, in which the nitrogen-containing components present in the stream comprising the first solvent are protonated, succeeds in extracting these impurities into the aqueous phase at high partition coefficients and low number of extraction stages. For example, the partition coefficient for amines when formic acid-containing extractants are used, depending on the concentration of the acid and the concentration of the amines, is in a range from about 10 to 10 000.

The extraction is effected generally at a temperature of from 5 to 100° C., preferably from 10 to 70° C., more preferably from 30 to 50° C.

For the extraction, the stream of the first solvent is contacted intimately with the extractant, a phase comprising the first solvent and an extractant phase enriched in nitrogen-containing impurities are allowed to separate from one another, and the extractant phase is removed. The contacting can be effected continuously or batchwise.

A plurality of batchwise separating operations can be carried out in cascade-like succession, in which case the phase which comprises the first solvent and is removed from the extractant phase is contacted in each case with a fresh portion of extractant and/or the extractant is conducted in countercurrent. For batchwise performance, the solvent and the extractant are contacted in a suitable vessel with mechanical motion, for example by stirring, the mixture is allowed to rest for phase separation, and one of the phases is removed, appropriately by drawing off the heavier phase at the bottom of the vessel.

To carry out the extraction continuously, the extractant and the stream of the first solvent are fed continuously to suitable apparatuses in an analogous manner to the batchwise variant.

The extraction is effected in at least one stage, for example in a mixer-settler combination. Suitable mixers are both dynamic and static mixers. An extraction in a plurality of stages is effected, for example, in a plurality of mixer-settlers or extraction columns.

When the aforementioned extractants which comprise at least one acid are used, the extraction is preferably effected by contacting with sufficient power input to restrict the necessary residence time. Preferred extraction apparatuses in this process variant are accordingly dispersion apparatuses with power input and extraction columns with power input, for example pulsed columns or columns with rotating internals.

In a preferred embodiment, the phase separation is improved by using at least one coalescence apparatus. This is preferably selected from coalescence filters, electrocoalescers and combinations thereof. When mixer-settler apparatuses are used for the extraction, it has been found to be advantageous to improve the phase separation by using coalescence filters such as candle or sand filters. The filter may be installed directly downstream of the mixer (stirred vessel) and/or in the organic outlet of the settler. Preference is further given to improving the phase separation by using electrocoalescers. These have been found to be useful for removing aqueous extraneous phases of up to 5% by mass. The use of coalescence apparatus in the process according to the invention is also suitable advantageously for settling finely dispersed aqueous phase out of the organic effluent of an extraction column.

In a preferred embodiment, the extraction is effected in at least one mixer-settler combination for the extraction of nitrogen-containing components from the stream of the first solvent. When organic extractants are used, a further mixer-settler combination is especially advantageous in order to subsequently reextract fractions of the first solvent which are transferred partly into the extractant with the nitrogen-containing components to be removed, and thus recycle them into the process.

After it has been worked up by extraction, the stream of the first solvent can be subjected to at least one further workup step for further purification. These include, for example, an adsorption, for which adsorbents known per se, such as activated carbon, zeolite or ion exchangers, can be used. Preference is given to using acidic ion exchangers.

It may be advantageous under some circumstances to subject the first solvent to a drying step before it is recycled into step a) and/or b). Suitable drying processes are the customary processes known to those skilled in the art, especially adsorption on dehydrating agents, for example using a zeolitic molecular sieve. In addition, the first solvent can also be dried by using a distillation, especially when the first solvent forms a heteroazeotrope with water. The drying can be effected either before or after the above-described workup steps.

The polyalkenylamine solutions obtained by the process according to the invention (in particular polybutenylamine and especially polyisobutenylamine) may be used advantageously as fuel or lubricant additives.

The invention is illustrated in detail with reference to the nonrestrictive examples which follow.

### EXAMPLE 1

a) Distillation

6.4 kg of highly reactive polyisobutene (Mₙ=1000 g/mol, PD=1.7, α- and β-olefin content=93%) were dissolved in 3.4 kg of SBP 100/140 special-boiling-point spirit (Shell Chemicals) and subjected to a hydroformylation at 185° C. and 280 bar of synthesis pressure (CO/H₂=4:6) in the presence of 115 g of 65% cobalt 2-ethylhexanoate solution as a catalyst. The dissolved oxo product thus obtained (65% in SBP 100/140 special-boiling-point spirit) was subjected without further workup to a reductive amination. The amination was carried out continuously in a tubular reactor (diameter 3 cm) over an amination catalyst (500 ml, Ni, Co, Cu) (conditions: loading 0.7 kg/h, temperature 200° C., molar NH₃/PIB-oxo ratio=80 mol/mol, pressure 200 bar, fresh gas 0.1 m³ (STP)/h of H₂). The reactor effluent obtained after the NH₃ removal was an on-spec product (degree of amination>88%). The polybuteneamine solution thus obtained was used as feed 1 for the distillation experiment which followed. The content of evaporable components was determined by evaporative concentration on a rotary evaporator and was 24.5%.

The second solvent used was kerosene (from Aral, boiling profile according to specification: 10% by volume max. 203° C., final boiling point max. 300° C.) (feed 2).

The distillation apparatus consisted of two glass bubble-cap tray columns K1 and K2, the feed 1 being conducted into K1 and the bottom effluent from K1 into an intermediate vessel and from there into K2. Feed 2 was conducted into the bottom of K2 at a temperature of 30° C.

The significant technical data of the columns were as follows:
K1:
Internal diameter 50 mm,
25 trays, feed of feed 1 to the 20^{th} tray from the bottom,
natural-circulation evaporator,
top condenser (intensive cooler, operated with cooling water of 22° C.) with downstream phase separator, top product and reflux to the column are withdrawn from the upper phase,
cold trap downstream of the top condenser.
K2:
Internal diameter 50 mm,
45 trays, feed of the bottom product from K1 to the 40^{th} tray from the bottom, feed of feed 2 into the bottom,
natural-circulation evaporator,
top condenser (intensive cooler, operated with cooling water of 22° C.) with condensate vessel, from which top product and reflux to the column are withdrawn,
cold trap downstream of top condenser,
vacuum pump downstream of cold trap.

The following operating parameters were established:
Feed 1: flow rate: 1000 g/h, temperature 30° C.,
K1 top product (upper phase) flow rate: 30 g/h,
K1 reflux rate (adjusted via bottom heater K1): 960 g/h,
K2 top pressure: 400 mbar abs.,
feed of K2 bottom product to K1: 900 g/h
feed 2: flow rate: 360 g/h, temperature 30° C.,
K2 top product flow rate: 180 g/h,
K2 reflux rate (adjusted via bottom heater K2): 321 g/h

Two hours after the start of the experiment, a steady operating state was attained. The following operating data were then measured:
K1 bottom temperature: 154.1° C.
K1 top temperature: 95.2° C.
K1 lower phase distillate flow rate: <10 g/h
K1 cold trap flow rate: <1 g/h
K2 bottom temperature: 190.2° C.
K2 top temperature: 83.8° C.
K2 cold trap flow rate: 2.6 g/h
K2 bottom product flow rate: 1108 g/h

The products drawn off from K2 were analyzed with regard to the distribution of the hydrocarbons present between them (by means of gas chromatography) and also to the sulfur content (determination according to Wickbold). The results are shown below:

| | K2 tops | K2 bottoms |
|---|---|---|
| Sulfur (mg/kg) | 2 | 11 |

| | K2 tops | K2 bottoms |
|---|---|---|
| | Area % | Area % |
| C7 hydrocarbons | 3.5 | |
| C8 hydrocarbons | 58.0 | |
| C9 hydrocarbons | 37.9 | |
| C10 hydrocarbons | 0.5 | 1.1 |
| C11 hydrocarbons | | 21.7 |
| C12 hydrocarbons | | 31.2 |
| C13 hydrocarbons | | 33.7 |
| C14 hydrocarbons | | 7.3 |
| C15 hydrocarbons | | |
| C16 hydrocarbons | | |
| C17 hydrocarbons | | 2.3 |

The results demonstrate that the inventive exchange of the solvent is possible while maintaining the limiting sulfur values required for recycling into the hydroformylation.

The top product from K2 was in turn used as feed for the extraction experiment described below.

b) Extraction:

### Example 1b1

The distillate stream from a) was extracted batchwise in a 2-stage cross-stream with 5% formic acid at 40° C. in an m_{formic acid}/m_{distillate} phase ratio=0.3. It was possible to reduce the nitrogen content from 310 mg/kg in the distillate stream to 0.4 and 0.2 mg/kg in raffinate 1 and raffinate 2 respectively. At 60° C., comparably good results were achieved.

### Example 1b2

Correspondingly to Example 1 b1, 5% sulfuric acid was used in three stages. The nitrogen content was reduced in the first stage to 6 mg/kg, and in the second and third stage to in each case 2 mg/kg. The fact that no difference was detected in the nitrogen concentration between second and third stage is due to the precision of analysis.

### Example 1b3

The distillate stream from a) was extracted continuously in cross-/countercurrent at 40° C. The extractant used in the second stage was 1% formic acid in a m_{1% FA}/m_{distillate} phase ratio=0.15. In the first stage, 20% formic acid was added and the total phase ratio was thus increased to (m_{1% FA}+m_{20% FA})/m_{distillate}=0.25. For a maximum-efficiency phase separation, an acrylic-phenol resin coalescence filter was used downstream of the first phase separator.

The nitrogen concentration of the distillate stream was 360 mg/kg and was reduced to 27.6 and 2.2 mg/kg in raffinate 1 and raffinate 2 respectively.

1. A process for preparing a polyalkenylamine, in which
a) a component which comprises at least one monounsaturated polyalkene is reacted with carbon monoxide and hydrogen to obtain a hydroformylated polyalkene, and
b) the resulting hydroformylated polyalkene is reacted with hydrogen and ammonia or an amine which has at least one primary or secondary amino group to give the polyalkenylamine,
which comprises, before carrying out at least one of steps a) and b), dissolving the polyalkene or the hydroformylated polyalkene in a first solvent and replacing the first solvent with a second solvent after this or the next step.

2. The process according to claim 1, in which steps a) and b) are both carried out in the presence of the first solvent and the first solvent is replaced with the second solvent after step b).

3. The process according to claim 1, in which the replaced first solvent is at least partly isolated and at least partly recycled into step a) and/or b) in which it is used as a solvent.

4. The process according to claim 1, in which the second solvent used is a medium having a higher boiling point than the first solvent and the first solvent is replaced by the latter being distilled out of the solution of the polyalkenylamine and the second solvent being added at least partly before and/or during the distillation.

5. The process according to claim 4, in which the boiling point or the final boiling point of the first solvent is at least 5 K lower than the boiling point or the initial boiling point of the second solvent.

6. The process according to claim 1, wherein the first solvent is a saturated aliphatic hydrocarbon, saturated cyclic hydrocarbon or a solvent mixture comprising a hydrocarbon.

7. The process according to claim 1, wherein the second solvent is an aromatic hydrocarbon or a mineral oil fraction comprising aromatic hydrocarbons.

8. The process according to claim 1, in which steps a) and b) are carried out in the first solvent and the effluent from step b) is subjected to at least one additional workup step to remove at least one reactant and/or at least one by-product and/or at least a portion of the first solvent.

9. The process according to claim 8, wherein an ammonia or amine-containing stream is initially removed from the effluent from step b).

10. The process according to claim 8, in which the effluent from step b), if appropriate after removal of an ammonia or amine-containing stream, is subjected to a distillation to replace the solvent and, during the distillation, a stream enriched in low-boiling by-products is discharged.

11. The process according to claim 8, in which the effluent from step b) is subjected to a distillation to replace the solvent, a stream comprising substantially the first solvent is isolated and this stream is subjected to at least one additional workup step to remove nitrogen-containing components.

12. The process according to claim 11, wherein the workup comprises an extraction, an adsorption or a combination thereof.

13. The process according to claim 12, wherein the workup comprises a liquid-liquid extraction.

14. The process according to claim 13, in which the separation of the liquid phases is improved by using a coalescence apparatus.

15. The process according to claim 14, in which the coalescence apparatus is at least one coalescence filters, electrocoalescers or combinations thereof.

16. The process according to claim 15, in which the coalescence apparatus used is at least one acrylic-phenol resin filter.

17. The process according to claim 13, in which the extractant is selected from the group consisting of water, dihydric and higher polyhydric alcohols, ionic liquids and mixtures thereof.

18. The process according to claim 17, in which the extractant additionally comprises at least one inorganic or organic acid.

19. The process according to claim 18, in which the acid is at least one selected from the group consisting of formic acid and sulfuric acid.
